(19) United States
(12) Patent Application Publication
(10) Pub. No.: US 2024/0193344 A1
(43) Pub. Date: Jun. 13, 2024

(54) Dynamically Partitioning and Superseding Documents

(71) Applicant: Gavin Burke, Oceanside, CA (US)

(72) Inventor: Gavin Burke, Oceanside, CA (US)

(21) Appl. No.: 18/419,446

(22) Filed: Jan. 22, 2024

Related U.S. Application Data
(63) Continuation-in-part of application No. 18/124,693, filed on Mar. 22, 2023, now abandoned.
(60) Provisional application No. 63/322,538, filed on Mar. 22, 2022.

(51) Int. Cl. G06F 40/103; G06F 40/166

(52) U.S. Cl. CPC G06F 40/103; G06F 40/166

(57) ABSTRACT

We present a formal specification for a language of dynamically-partitioned documents. Its syntactic and semantic invariants allow the selective traversal and manipulation of its members. Realized in a physical setting. a memory includes a document-partitioning module with instructions executed by a processor to dynamically partition and supersede a plurality of subspaces nested in a document.

### CROSS REFERENCE TO RELATED APPLICATIONS

This application claims priority to a co-pending U.S. patent application Ser. No. 18/123,693 filed Mar. 22, 2023 entitled “Dynamically Partitioning and Superseding Machine-Readable Documents”, which claims priority to U.S. Provisional Application Ser. No. 63/322,538 filed Mar. 22, 2022 entitled “Dynamically Partition-ing and Superseding Machine-Readable Documents”, the entire contents of each of which are hereby incorporated by reference.

### TECHNICAL FIELD

This patent application relates generally to computation for manipulating documents.

### BACKGROUND

Documents realized in a digital setting typically comprise a mere single su-persedable space or a plurality of supersedable subspaces which are static in size and/or number. Such documents are consequently populated with empty or otherwise superfluous space. Moreover, the user may consequently have fewer opportunities to selectively manipulate portions of the document: the user may be forced to supersede the entirety of a document rather than a select portion of it upon traversing from one “space” of information to another. Accordingly, an object of the present invention is to allow the selective manipulation and traversal of documents.

### SUMMARY

The foregoing and other objects are achieved in a document-partitioning module with instructions executed by a processor to dynamically partition and supersede a plurality of subspaces nested in a document. A document nests a plurality of subspaces, each housing information visible to a user and each individually supersedable. The subspaces are dynamic in both size and number: the size and number of them mutate in response to changes in the size of the document. Our language of dynamically-partitioned documents upholds various invariants: e.g., the visible subspaces are non-overlapping, and they together comprise the entireties of the documents. User-generated events in portions of the documents engender new information and restore previous information in them.

### BRIEF DESCRIPTION OF THE DRAWINGS

FIG. 1 gives a formal grammar for a language of dynamically-partitioned documents, called DPD;

FIGS. 2A-C specify judgments for deciding membership in language DPD and for establishing auxiliary properties of its documents;

FIGS. 3A-H give rules for deciding membership in DPD;

FIGS. 4A-D describe the manipulation of documents in DPD in response to user input;

FIGS. 5A-D illustrate manipulations of documents in DPD in response to user input;

FIGS. 6A-D illustrate the superseding of subspaces in documents of DPD in response to user input;

FIGS. 7A-J introduce a more involved language of dynamically-partitioned documents, called DPDv2, and illustrate manipulations to its members.

### DETAILED DESCRIPTION OF PREFERRED EMBODIMENTS

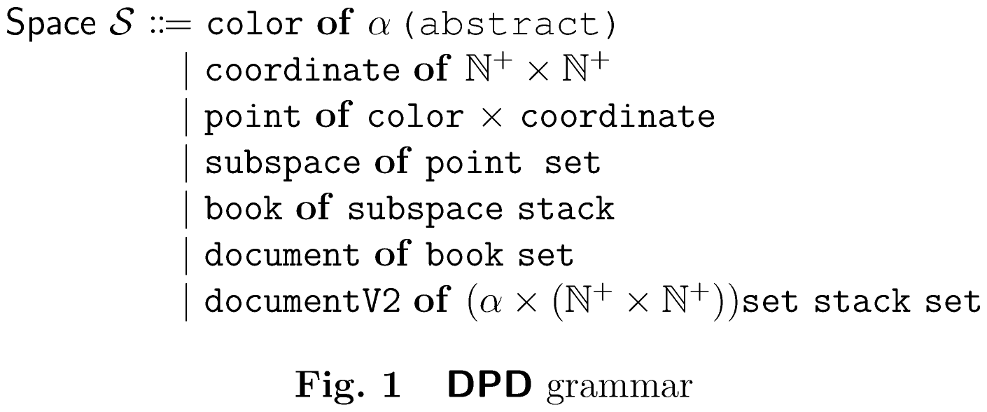

Referring now to FIG. 1, we give a formal grammar for our language of dynamically-partitioned documents, which we call DPD:
Space [symbol] ::=color of α (abstract)
   coordinate of [symbol] ⁺× [symbol] ⁺
   point of color×coordinate
   subspace of point set
   book of subspace stack
   document of book set
   documentV2 of (α×( [symbol] ⁺× [symbol] ⁺))set stack set
      We have as primitive constructs a color α, whose representation we leave abstract, and a coordinate, given by a pair of positive naturals [symbol] ⁺× [symbol] ⁺. We call a pairing of a color together with a coordinate (α×( [symbol] ⁺× [symbol] ⁺) a point. A subspace is a set of points, which together form a two-dimensional space. We call a stack of subspaces residing over the same portion of a document a book. A document is a set of books that together comprise the entirety of its space. We express this same construct as documentV2, which specifies the structure of the data using only primitive constructs.

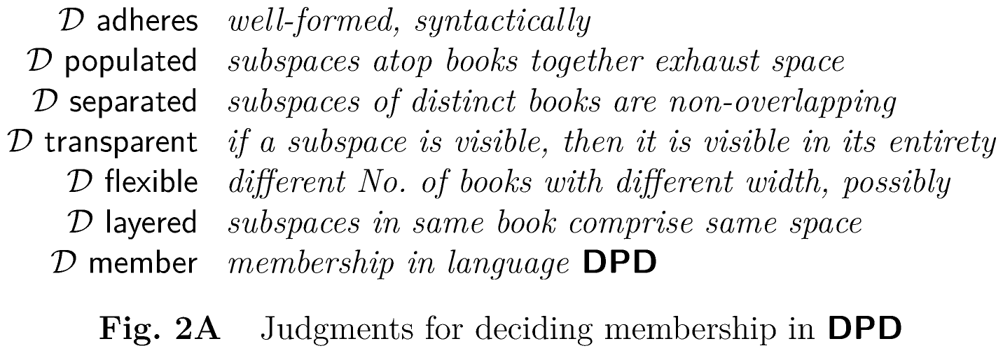

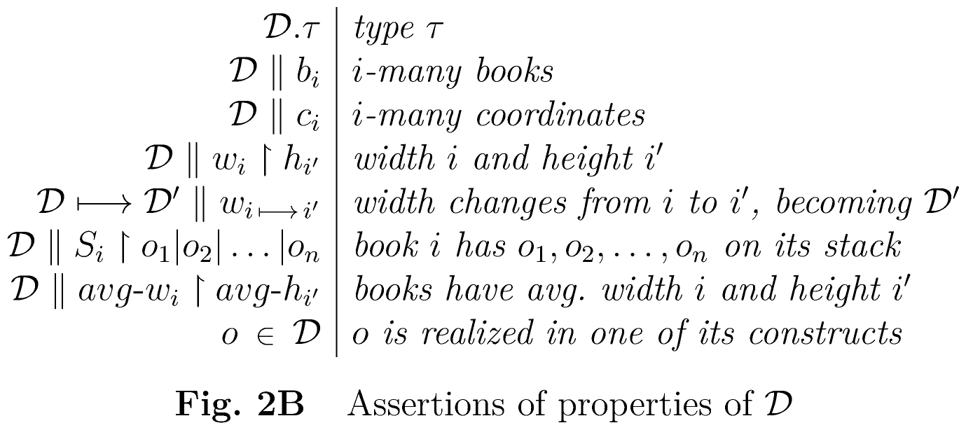

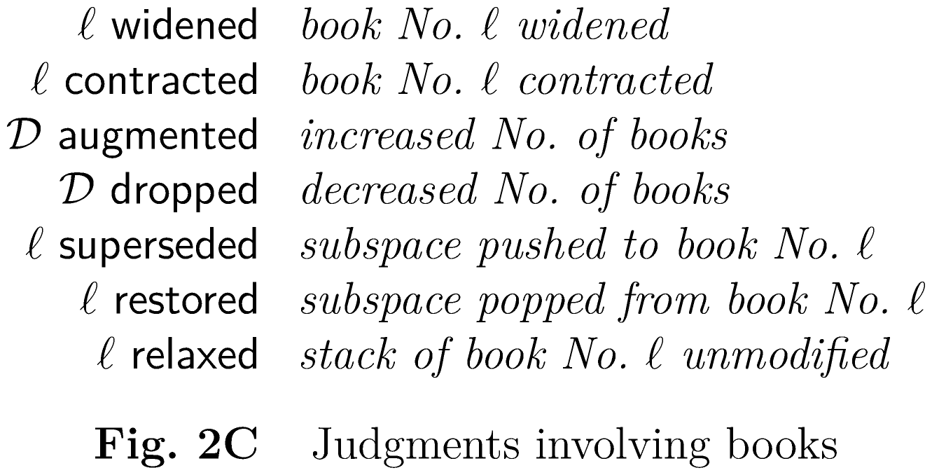

In FIG. 2A, we express various informal judgments that together establish membership in our language DPD:

| | |
|---|---|
| [symbol] adheres | well-formed, syntactically |
| [symbol] populated | subspaces atop books together exhaust space |
| [symbol] separated | subspaces of distinct books are non-overlapping |
| [symbol] transparent | if a subspace is visible, then it is visible in its entirety |
| [symbol] flexible | different No. of books with different width, possibly |
| [symbol] layered | subspaces in same book comprise same space |
| [symbol] member | membership in language DPD |

We say that the document [symbol] adheres to express that it is syntactically well-formed, adhering to the foregoing grammar. We say it is populated when subspaces together exhaust its space: every point within the scope of the document is contained in a subspace. The separation judgment maintains that its subspaces in different books are non-overlapping. The judgment that the document is layered asserts that subspaces belonging to the same book comprise the same space. Arbitrary, distinct subspaces [symbol] and [symbol] ′ are either entirely overlapping, in which case they belong to the same book, or are not whatsoever overlapping, in which case they belong to different books. Only the subspace at the top of the stack of a given book is visible from the perspective of a user. We assert that the document is transparent when the visibility of a subspace [symbol] implies the visibility of [symbol] in its entirety. The flexibility judgment holds that a different No. of subspaces populate the document with a different width of the document for some threshold. We write that [symbol] is a member to assert its membership in our language DPD, which holds when each of the above-written assertions hold.

FIG. 2B expresses various judgments involving the documents in question, to be exploited in the rules that follow:

| | |
|---|---|
| [symbol] . [symbol] | type [symbol] |
| [symbol] ∥ [symbol] | [symbol] -many books |
| [symbol] ∥ [symbol] | [symbol] -many coordinates |
| [symbol] ∥ [symbol] [symbol] [symbol] | width i and height i' |
| [symbol] [symbol] [symbol] ' ∥ wᵢ [symbol] _{i′} | width changes from i to i', becoming [symbol] ' |
| [symbol] ∥ Bᵢ [symbol] o₁\|o₂\| . . . \| oₙ | book i has o1, o2, . . . , oₙ on its stack |
| [symbol] ∥ avg-wᵢ [symbol] avg-h_{i′} | books have avg. width i and height i' |
| o ∈ [symbol] | o is realized in one of its constructs |

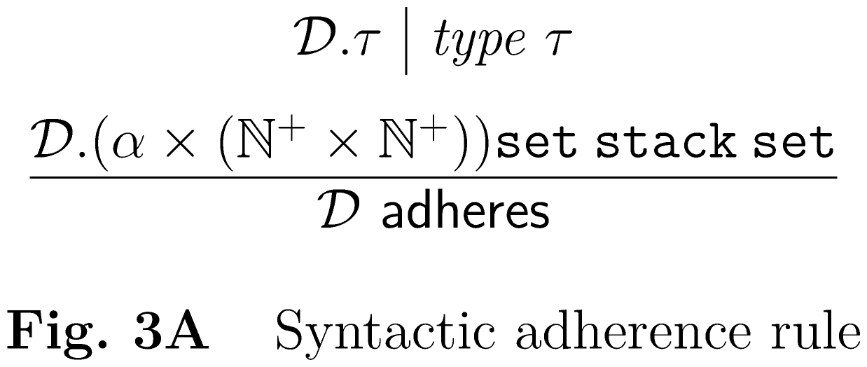

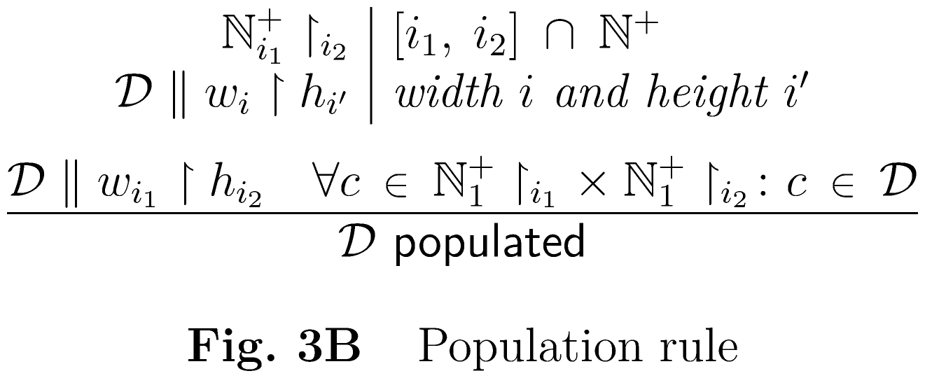

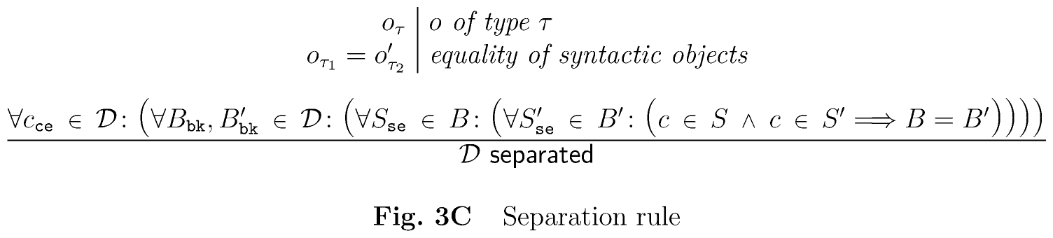

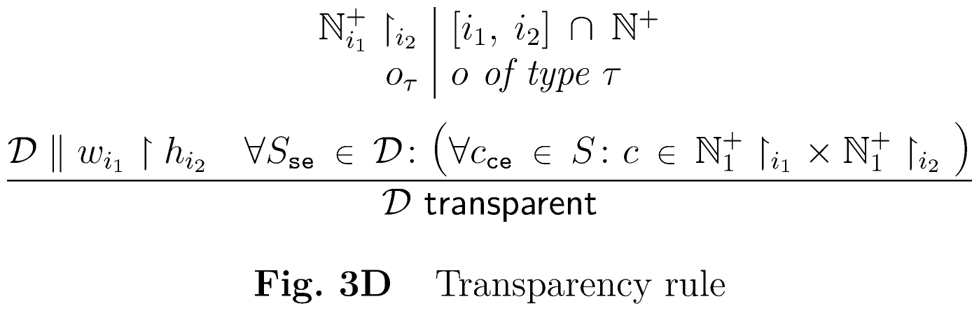

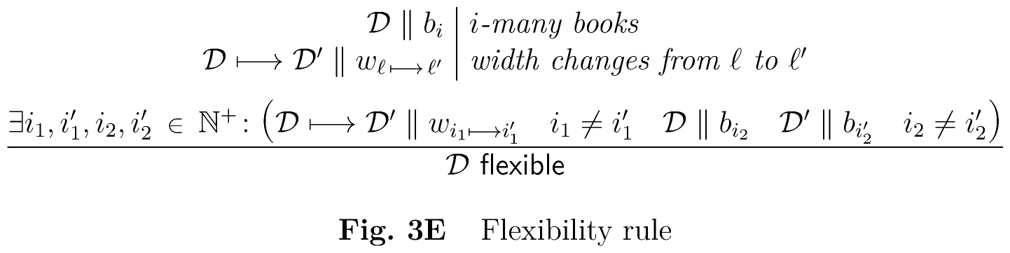

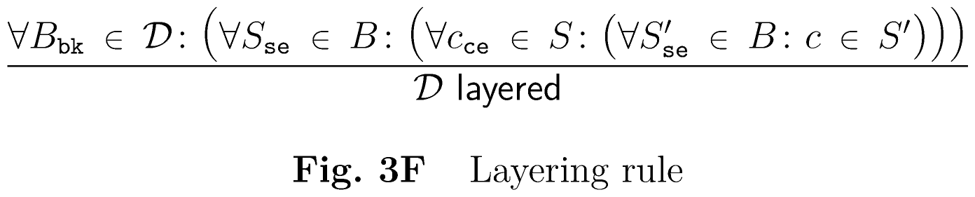

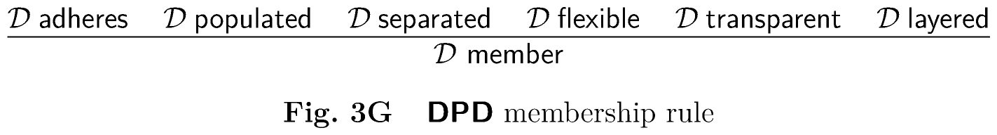

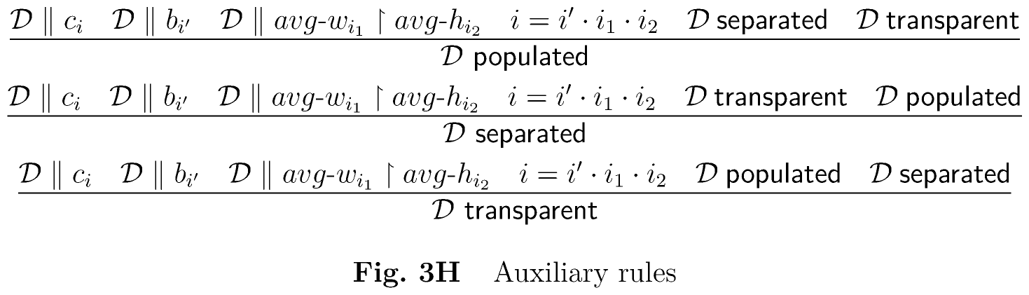

They appear in the premises of the rules of FIGS. 3A-F for establishing other judgments.

FIG. 2C also expresses judgments involving documents:

| | |
|---|---|
| [symbol] widened | subspace atop book No. [symbol] widened |
| [symbol] contracted | subspace atop book No. [symbol] contracted |
| [symbol] augmented | increased No. of books |
| [symbol] dropped | decreased No. of books |
| [symbol] superseded | subspace pushed to book No. [symbol] |
| [symbol] restored | subspace popped from book No. [symbol] |
| [symbol] relaxed | stack of book No. [symbol] unmodified |

They annotate sketches that appear in subsequent figures to allow the reader to more easily reason about induced behavior.

FIGS. 3A-G formally specify necessary and sufficient conditions for the assertion of the foregoing judgments. A collection of rules allow their derivation. We write [symbol] ᵢ_{₁}⁺ [symbol] to express the set of positive naturals [ [symbol] ₁, [symbol] ₂]∩ [symbol] ⁺ and o_{τ}to denote a syntactic object o of type [symbol] , with =denoting equality between them. We abbreviate the names of types by writing just their first and last letters and drop the type annotation when the type is specified in the surrounding context. Abusing notation, we write o∈O to indicate that an object o is realized in a construct of another object O. We also write the symbol ∈ in the standard way, to indicate set membership. We now spell out the intuition behind each of the rules, which allow us to formally decide on membership in our language DPD.
[symbol] . We assert by rule

$$\frac{𝒟 . ( α \times ( {ℕ}^{+} \times {ℕ}^{+} ) ) set stack set}{𝒟 adheres}$$

that [symbol] adheres to the foregoing grammar if it is of type (α×( [symbol] ⁺× [symbol] ⁺)) set stack set.
[symbol] . We assert with the rule

$$\frac{𝒟 ‖ {w}_{{i}_{1}} ↾ {h}_{{i}_{2}} ∀ c ∈ {ℕ}_{1}^{+} {↾}_{{i}_{1}} \times {ℕ}_{1}^{+} {↾}_{{i}_{2}} : c ∈ 𝒟}{𝒟 populated}$$

that [symbol] is populated if with some width [symbol] ₁ and height [symbol] ₂ ( [symbol] ∥ [symbol] [symbol] [symbol] ), all coordinates within the requisite scope are realized in constructs of [symbol] (∀c∈ [symbol] ₁⁺ [symbol] × [symbol] ₁⁺ [symbol] : c∈ [symbol] ).
[symbol] . The rule

$$\frac{∀ {c}_{c e} ∈ 𝒟 : ( ∀ {B}_{bk} , {B}_{b k}^{′} ∈ 𝒟 : ( ∀ {S}_{s e} ∈ B : ( ∀ {S}_{s e}^{′} ∈ {B}^{′} : ( c ∈ S ∧ c ∈ {S}^{′} ⇒ B = {B}^{′} ) ) ) )}{𝒟 separated}$$

asserts that [symbol] is separated if for all coordinates c and subspaces [symbol] and [symbol] ′ in [symbol] , the occurrence of c in both [symbol] and [symbol] ′ implies the appearance of [symbol] and [symbol] ′ under the same book.
[symbol] v. We assert with rule

$$\frac{𝒟 ‖ {w}_{{i}_{1}} ↾ {h}_{{i}_{2}} ∀ {S}_{s e} ∈ 𝒟 : ( ∀ {c}_{c e} ∈ S : c ∈ {ℕ}_{1}^{+} {↾}_{{i}_{1}} \times {ℕ}_{1}^{+} {↾}_{{i}_{2}} )}{𝒟 transparent}$$

that the document [symbol] , with width [symbol] ₁ and height [symbol] ₂ ( [symbol] ∥ [symbol] [symbol] [symbol] ), is transparent if for every subspace [symbol] in [symbol] and every coordinate c in [symbol] , c is within the scope of the document (c∈ [symbol] ₁⁺ [symbol] × [symbol] ₁⁺ [symbol] ).
v. The rule

$$\frac{∃ {i}_{1} , {i}_{1}^{′} , {i}_{2} , {i}_{2}^{′} ∈ {ℕ}^{+} : ( 𝒟 ↦ {𝒟}^{′} ‖ {w}_{{i}_{1} ↦ {i}_{1}^{′}} {i}_{1} \neq {i}_{1}^{′} 𝒟 ‖ {b}_{{i}_{2}} {𝒟}^{′} ‖ {b}_{{i}_{2}^{′}} {i}_{2} \neq {i}_{2}^{′} )}{𝒟 flexible}$$

asserts that if [symbol] can change its width from [symbol] ₁ to [symbol] ′₁ ( [symbol] [symbol] [symbol] ′∥wᵢ_{₁} [symbol] _{i′}_{₁}) and in effect modify its No. of books from [symbol] ₂ to [symbol] ′₂, then [symbol] is flexible.
v [symbol] . The rule

$$\frac{∀ {B}_{b k} ∈ 𝒟 : ( ∀ {S}_{s e} ∈ B : ( ∀ {c}_{c e} ∈ S : ( ∀ {S}_{s e}^{′} ∈ B : c ∈ {S}^{′} ) ) )}{𝒟 layered}$$

expresses, intuitively, that [symbol] is coherent if each subspace under an arbitrary book shares precisely the same coordinates/space.
v [symbol] . The final rule

$$\frac{𝒟 adheres 𝒟 populated 𝒟 separated 𝒟 flexible 𝒟 transparent 𝒟 layered}{𝒟 member}$$

asserts that the foregoing judgments together allow us to conclude [symbol] to have membership in language DPD.
   FIG. 3H gives auxiliary rules for deriving the judgments that [symbol] is populated, separated, and transparent.

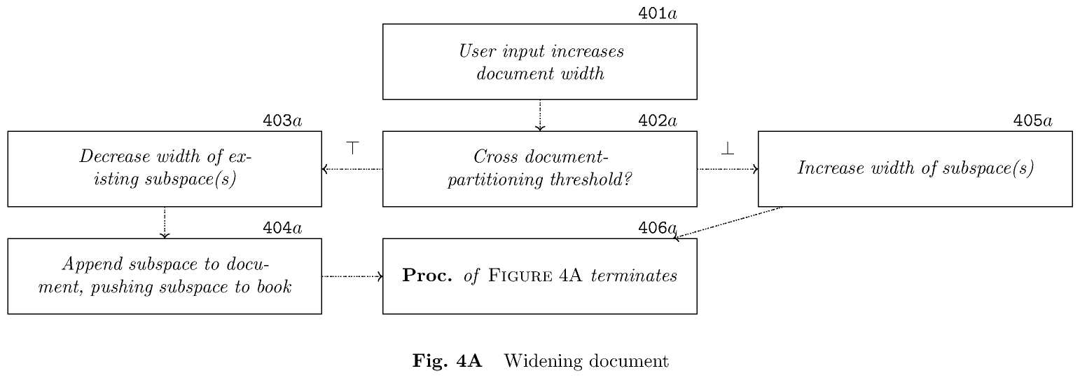

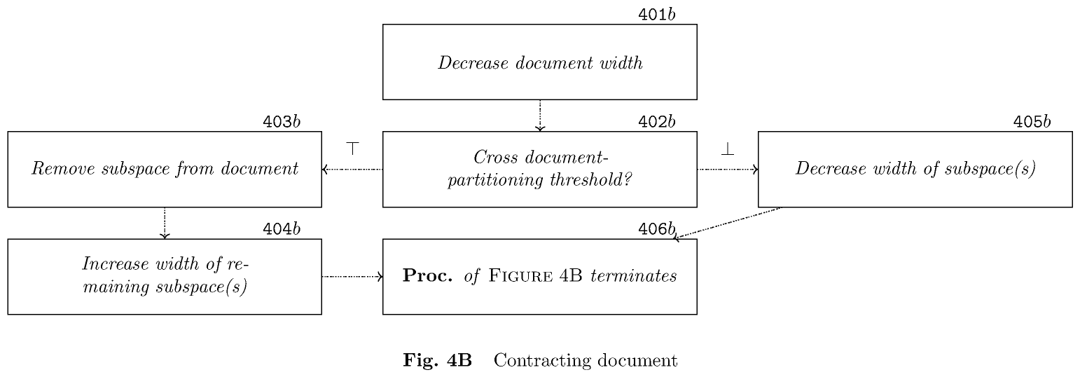

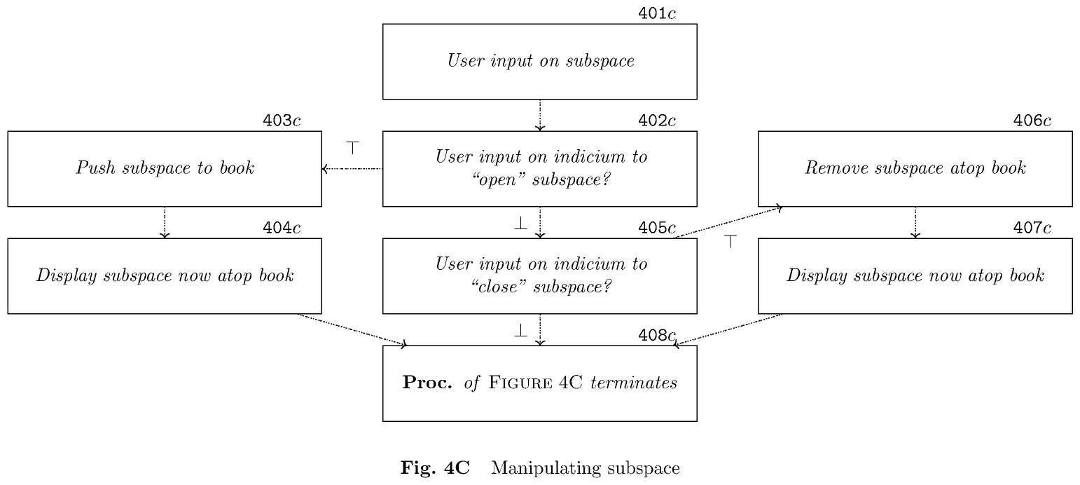

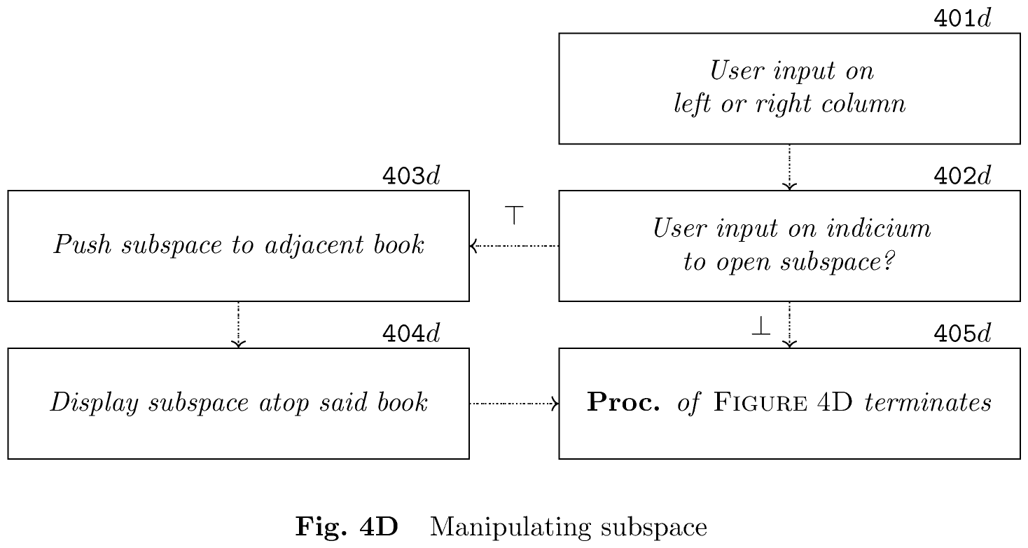

Referring now to FIG. 4A, a procedure for modifying the size and/or number of subspaces populating a document is illustrated. The procedure is invoked by user input that increases the width of a document (401a). If at least one of a plurality of document-partitioning thresholds is crossed as a result (402a- [symbol] ), the width of one or more subspaces is decreased (403a), and a new subspace is appended to the document (404a); otherwise (402a- [symbol] ), the width of one or more subspaces is increased (405a). The procedure terminates in step 406a.

Document-partitioning thresholds may be at, e.g., widths 300 u, 600 u, 900 u, and 1,200 u for some unit u. In this case, the No. of subspaces in relation to the width of the document may be as follows:

| | | |
|---|---|---|
| one subspace | [symbol] | the width is 1-300 u; |
| two subspaces | [symbol] | the width is 301-600 u; |
| three subspaces | [symbol] | the width is 601-900 u; |
| four subspaces | [symbol] | the width is 901-1, 200 u. |

Throughout and following the execution of the procedure, the subspaces remain non-overlapping and still comprise the entirety of the document. This desirably allows a greater amount of space in the document to be exploited by the user.

The procedure described in FIG. 4B is similar; it likewise modifies the size and/or number of subspaces populating a document. This procedure is invoked by user input decreasing the width of the document (401b). If at least one of the document-partitioning thresholds is crossed (402b- [symbol] ), a subspace is removed from the document (403b), and the width of one or more of the remaining subspaces is increased (404b); otherwise (402b- [symbol] ), the width of one or more subspaces is decreased (405b). In step 406b, the procedure terminates.

FIG. 4C describes a procedure for modifying a “book,” i.e., a stack of subspaces, in response to user input. The user input may include contact with a peripheral device. If the user input is to “open” a subspace (402c- [symbol] ), a subspace is pushed to the corresponding book (403c) and becomes visible to the user (404c). If the user input is to “close” a subspace (405c- [symbol] ), the subspace at the top of the book is removed (406c), and the subspace consequently at the top of the book is displayed to the user (407c). The book is left unchanged if the user input is neither to “open” nor “close” a subspace (402c- [symbol] ; 405c- [symbol] ). The procedure terminates in step 408c.

FIG. 4D describes a procedure for pushing subspaces to books in response to user input in auxiliary space. The procedure is invoked specifically by user input on a left- or right-side column in a document (401d). If the event is particularly on an indicium to open a subspace (402d- [symbol] ), then a subspace is pushed to a book to its right or left (403d), and the subspace previously atop the book is superseded with the information contents of the pushed subspace (404d); otherwise (402d- [symbol] ), the procedure immediately terminates (405d). (We call a subspace active if and only if it is visible in the document. And a subspace is visible if and only if it is at the top of a book.)

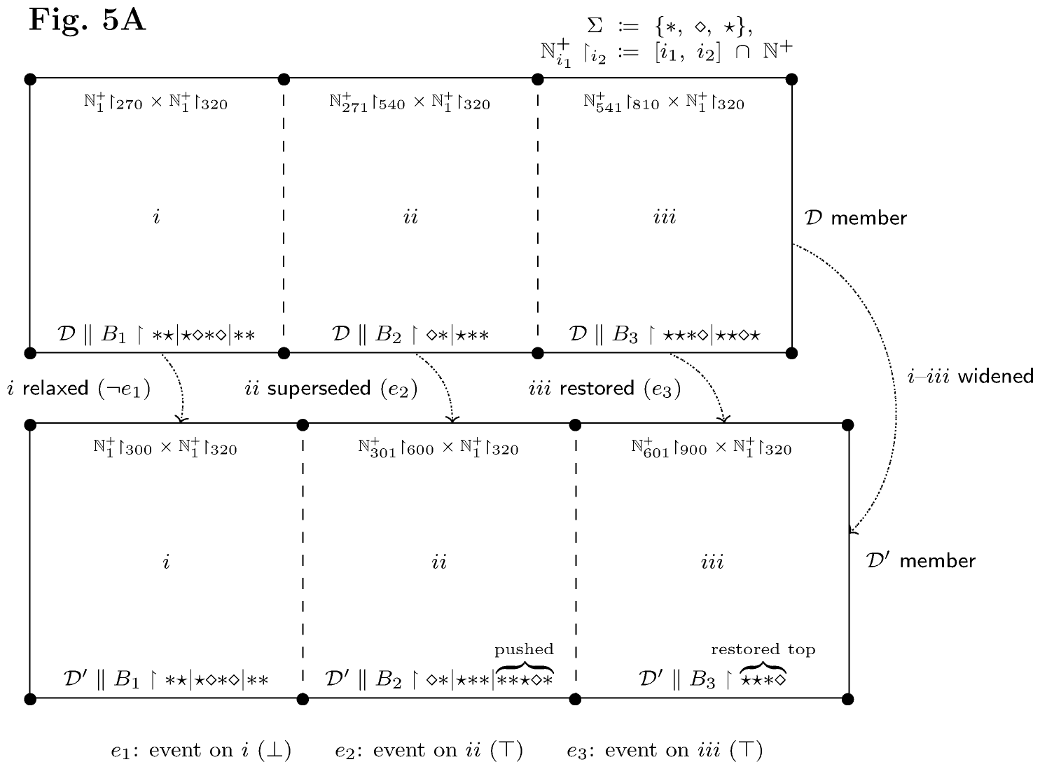

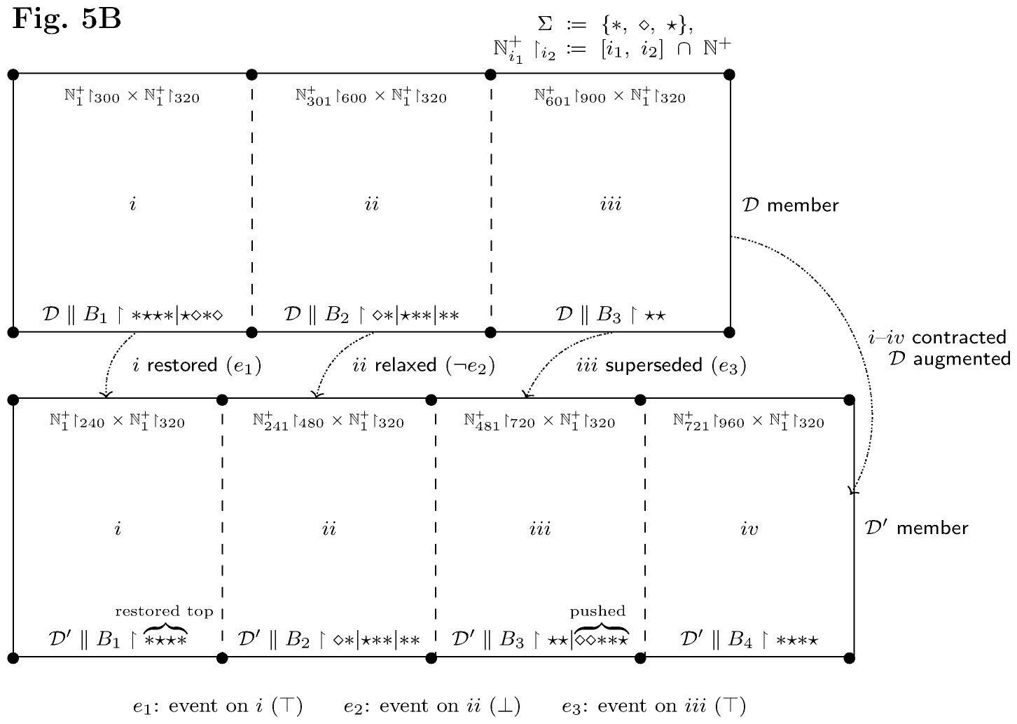

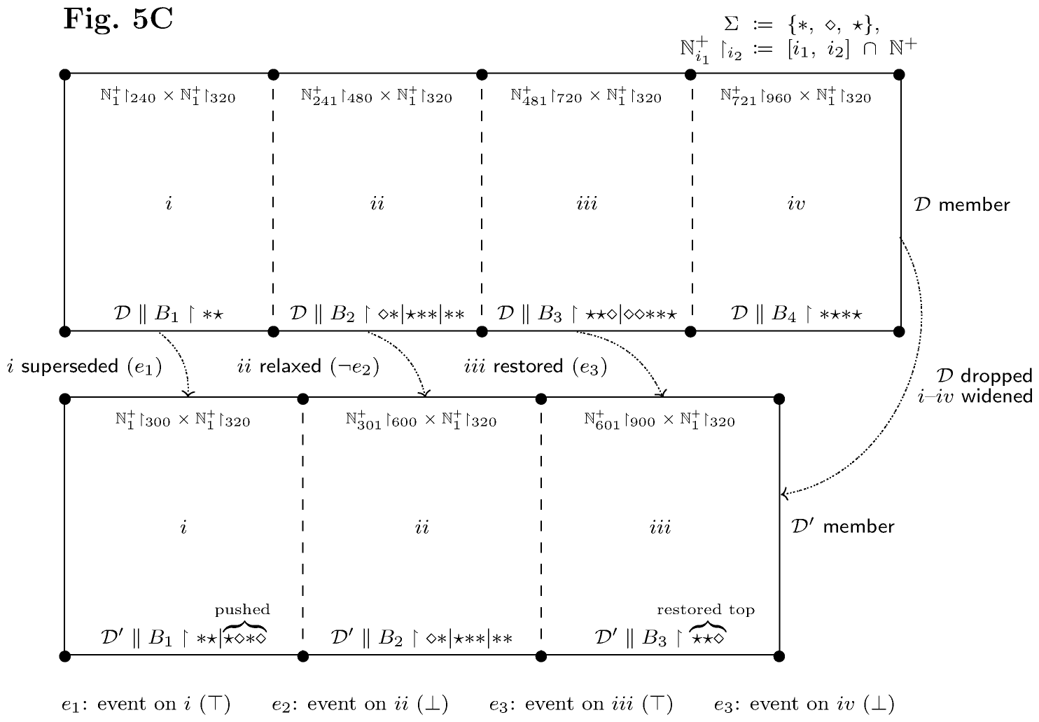

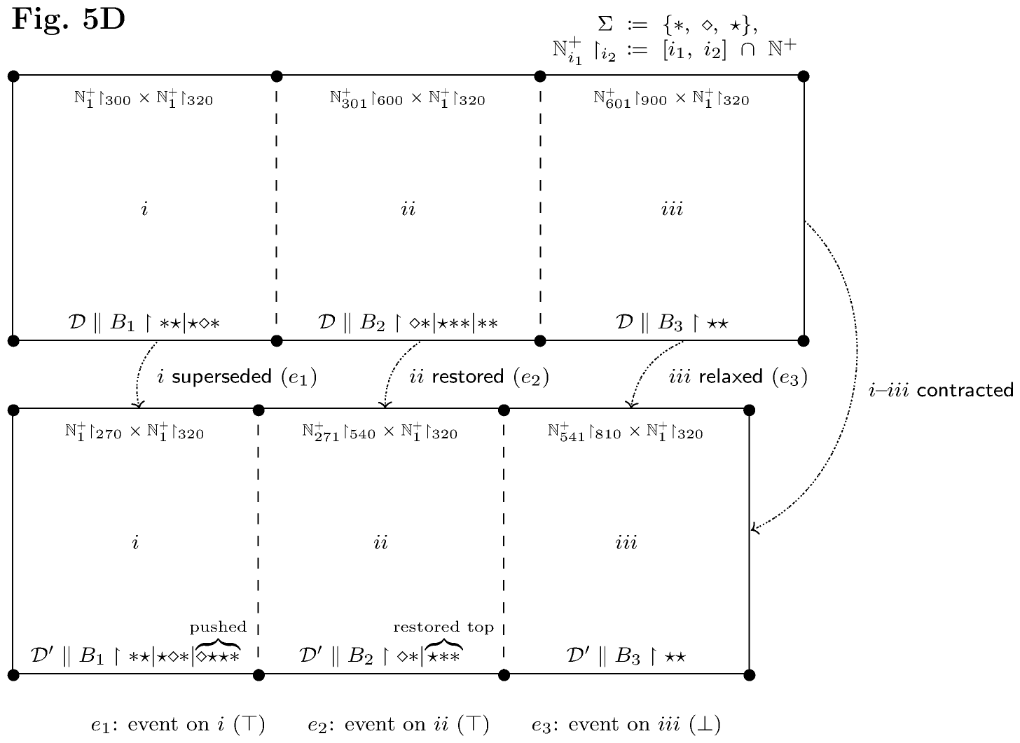

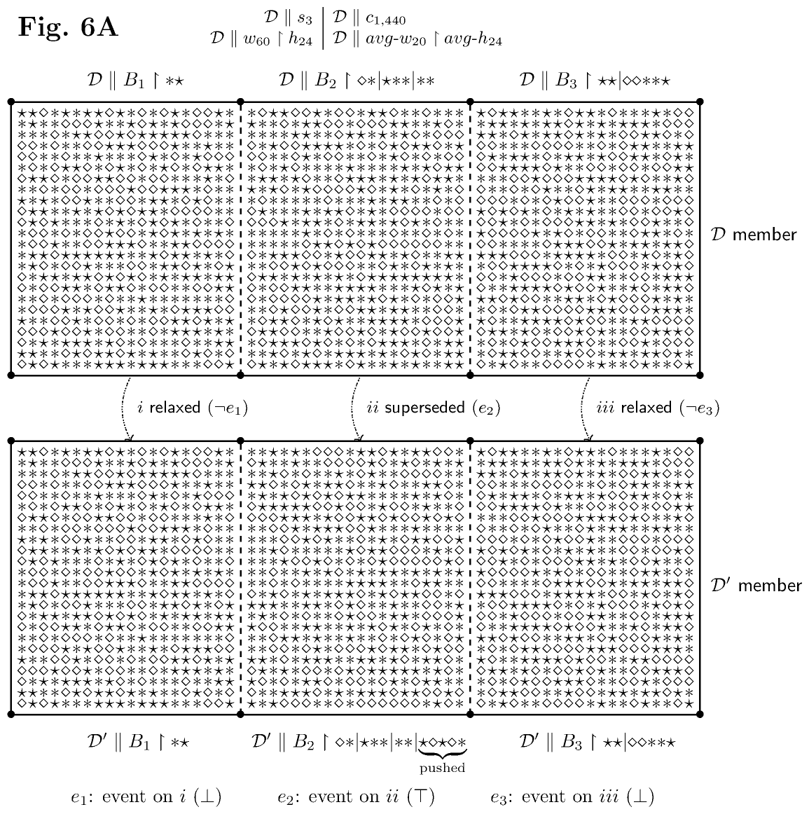

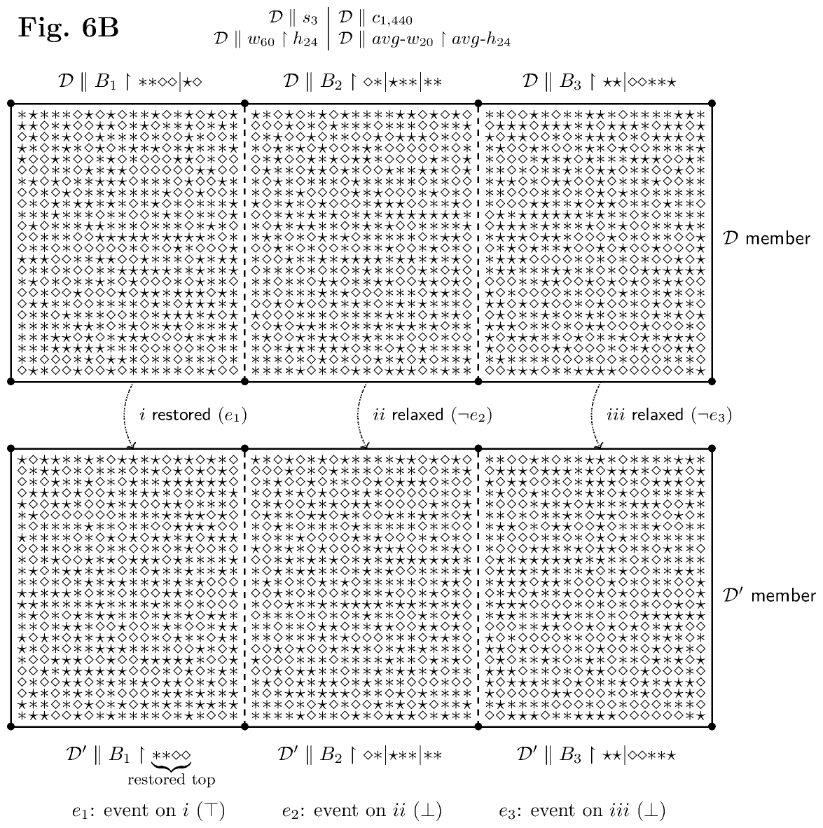

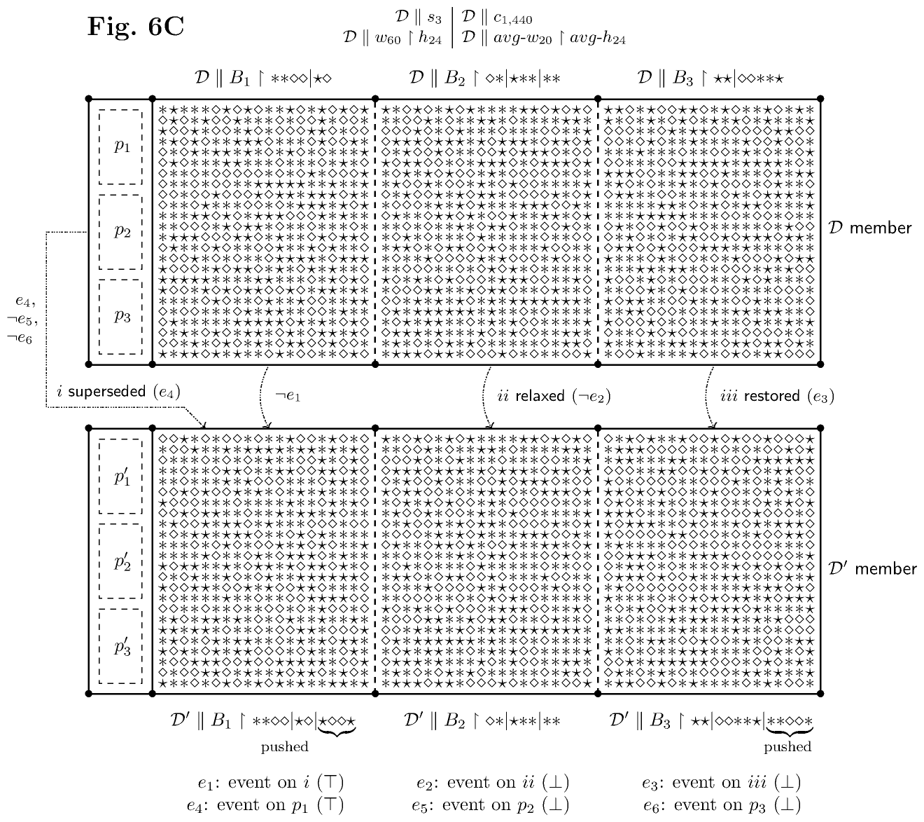

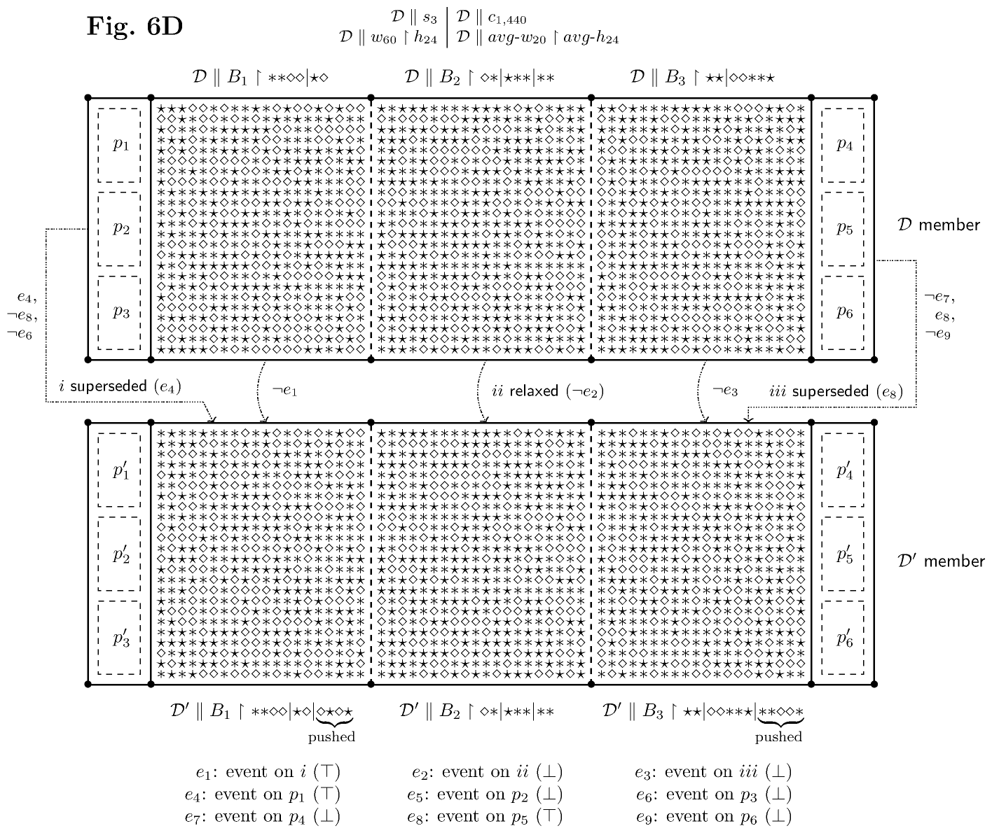

We introduce some conventions and notation used in FIGS. 5A-6D. Documents are enclosed with solid lines. Subspaces nested in them are partitioned about dashed lines. An “original” document is displayed towards the top of the figures, and the document after modifications resulting from user input is displayed towards the bottom. The original and new documents are annotated with [symbol] member and [symbol] ′ member, respectively, to indicate their membership in our language DPD. We specify identifiers for elements of the books in FIGS. 5A-6D and the information contents of subspaces in FIGS. 6A-D with strings over a three-symbol alphabet Σ:={*, ★, ⋄}. We delimit the identifiers with a vertical bar, |, with the identifier for the top subspace of a given book written towards the right. We specify the set of coordinates for subspaces in FIGS. 5A-D towards the top of the subspaces by writing [symbol] ᵢ_{₁}⁺ [symbol] × [symbol] _{i′}_{₁}⁺ [symbol] [symbol] for [symbol] , [symbol] ₂ [symbol] ′₁, [symbol] ′₂, ∈ [symbol] ⁺ with [symbol] ₁< [symbol] ₂ and [symbol] ′₁ [symbol] ′₂. As before, [symbol] ᵢ_{₁}⁺ [symbol] :=[ [symbol] ₁, [symbol] ₂]∩ [symbol] ⁺. Arrows are annotated with judgments and literals that indicate the behavior of the document and whether given events arose.

Referring now to FIG. 5A, manipulations to a document are illustrated. The document is populated with three subspaces labelled with [symbol] , [symbol] , and [symbol] . Each subspace has one associated stack, and they respectively have three, two, and two members, as indicated by the vertical bars that delimit them. The subspaces are each of size 270 u by 320 u for some unit u. In the document, the second subspace initially has its x-coordinates from 271 u to 540 u and its y-coordinates from 1 u to 320 u; then, it has its x-coordinates from 301 u to 600 u and its y-coordinates still from 1 u to 320 u. The dimensions for the other subspaces can be interpreted similarly. User input expands the document rightwards, increasing its size (per step 401a of FIG. 4A) to an extent such that a document-partitioning threshold is not crossed (402a- [symbol] ); accordingly, the width of each subspace then increases from 270 u to 300 u (405a). The subspaces still together comprise the entirety of the document and are still visible in their entireties, maximizing exploitable space. User input occurs in the second and third subspaces (401c), respectively pushing to (402c- [symbol] ; 403c) and removing from the top of (402c- [symbol] ; 405c- [symbol] ); 406c) their stacks. The information contents of the first subspace is preserved; the second subspace introduces new information (its identifier being “**★⋄*”) (404c); the third subspace restores information presented there earlier (“★★⋄★” was deleted) (407c).

In FIG. 5B, user input further expands the document rightwards, increasing its width (401a). A document-partitioning threshold is crossed (402a- [symbol] ), so the width of each existing subspace decreases from 300 u to 240 u (403a), and a fourth subspace is appended to the document (404a). By reducing the size of each subspace and appending a new one in response to the increase in the size of the document, the subspaces each retain a manageable amount of space for a user, and exploitable space is maximized. User input occurs in the first and third subspaces (401c), respectively removing from the top of (402c- [symbol] ; 405c- [symbol] ; 406c) and pushing to (402c- [symbol] ; 403c) their stacks. The first subspace restores information presented there earlier (407c); the information contents of the second subspace is preserved; and the third subspace introduces new information (404c).

In FIG. 5C, user input contracts a document from its right side, decreasing its width (401b). A document-partitioning threshold is crossed (402b- [symbol] ), so the fourth subspace is removed from the document (403b), and the width of each of the three remaining subspaces increases from 240 u to 300 u (404b). User input occurs in the first and third subspaces (401c), respectively pushing to (402c- [symbol] ; 403c) and removing from the top of (402c- [symbol] ; 405c- [symbol] ; 406c) their stacks. The first subspace introduces new information (404c); the information contents of the second subspace is preserved; the third subspace restores information presented there earlier (407c).

In FIG. 5D, user input further contracts a document from its right side, decreasing its width (401b). A document-partitioning threshold is not crossed (402b- [symbol] ), so the width of each of the three subspaces decreases from 300 u to 270 u (404b). User input occurs in the first and second subspaces (401c), respectively pushing to (402c- [symbol] ; 403c) and removing from the top of (402c- [symbol] ; 405c- [symbol] ; 406c) their stacks. The first subspace introduces new information (404c); the second subspace restores information presented there earlier (407c); the information contents of the third subspace is preserved.

Referring now to FIG. 6A, a mutation to the information contents of a subspace is illustrated. User input occurs in the second of three active subspaces (401c) to “open” a subspace (402c- [symbol] ), causing a new subspace to be pushed to its book (403c) and the information contents of this new subspace to be displayed (404c). The user input is indicated with the atom e₂ and the transformation with the judgment that [symbol] is superseded. We write the annotation “pushed” towards the bottom of the figure to highlight the identifier, ★⋄★⋄*, for the pushed subspace. The new information is represented by a new sequence of symbols over the alphabet Σ discussed earlier. The same sequence of symbols appears in the first and third active subspaces, as they are left unmodified. The absence of a transformation is indicated with the judgments that [symbol] is relaxed and likewise that [symbol] is relaxed. The absence of user input in the first and third subspaces is indicated with the literals ¬e₁ and ¬e₃. Auxiliary information about the original document appears towards the top of the figure. As before, and likewise in the subsequent figures, the original and new documents are annotated with the judgments that [symbol] is a member and likewise that [symbol] ′ is a member to indicate their membership in our language DPD.

In FIG. 6B, another mutation to the information contents of a subspace is illustrated. User input occurs in the first of three active subspaces (401c) to “close” a subspace (402c- [symbol] ; 405c- [symbol] ), causing the subspace atop the first book to be removed (406c) and the information contents of the subspace now atop the first book to be displayed (407c). The user input is indicated with the atom e₁ and the transformation with the judgment that [symbol] is restored. We write the annotation “new top” towards the bottom of the figure to highlight the identifier, ★⋄★⋄* , for the subspace now atop the stack of the book. The information contents of the second and third subspaces is preserved; their absence of transformation is indicated with the judgments that [symbol] is relaxed and similarly that [symbol] is relared. The literals ¬e₂ and ¬e₃ indicate the absence of user input in the second and third subspaces. Between documents [symbol] and [symbol] ′, the same sequence of symbols can be observed in the second and third subspaces, and a different sequence of symbols can be observed in the first subspace. This reflects the respective preservation and transformation of the information contents of the subspaces.

In FIG. 6C, there is a document with three “main” subspaces, called [symbol] , [symbol] , and [symbol] , and a left-side column, called [symbol] . This left-side column is a subspace in a book with an immutable stack. User input occurs in the left-side column (401d). The input is particularly on an indicium marked p1 for opening a subspace (402d- [symbol] ); its occurrence is indicated with the atom e₄. Accordingly, a subspace is pushed to the left-most book (403d), and the left-most “main” subspace (immediately to the right of the left-side column) is superseded with the information contents of the pushed subspace (404d). We write the judgment that [symbol] is superseded to indicate this. The literal ¬e₁ is written to indicate an absence of user input directly in the first subspace; this reflects the ability to supersede its contents by means other than user input directly in it. User input also occurs in the third “main” subspace (401c) to “close” a subspace (402c- [symbol] ; 405c- [symbol] ), causing the subspace atop the third book to be removed (406c) and the information contents of the subspace now atop the third book to be displayed (407c). The information contents of the second subspace is preserved; we write the judgment that [symbol] is relaxed to indicate its lack of transformation and the literal ⊥e₂ to indicate an absence of user input in it.

In FIG. 6D, there is a document again with three “main” subspaces, called [symbol] , [symbol] , and [symbol] , and with left- and right-side columns, called [symbol] v and v. The left- and right-side columns are subspaces held in immutable stacks. User input occurs in the left-side column (401d). It occurs particularly on an indicium marked p₃ for “opening” a subspace (402d- [symbol] ). So, a subspace is pushed to the left-most book (403d), and the left-most “main” subspace is superseded with the information contents of the pushed subspace (404d). Similarly, user input occurs on the right-side column (401d), specifically on an indicium marked ps for “opening” a subspace (402d- [symbol] ); hence, a subspace is pushed to the right-most book (403d), and the right-most “main” subspace is superseded with the information contents of the pushed subspace (404d). We write the atoms e₄ and e₈, and the judgments that [symbol] is superseded and that [symbol] is superseded, to indicate the above-described user input and transformations. We twice write the annotation “pushed” towards the bottom of the figure to highlight the identifiers, ⋄★⋄★ and **⋄⋄*, for the pushed subspaces. There is an absence of user input and transformation in the second subspace; we indicate this with the literal ¬e₂ and the judgment that [symbol] is relaxed.

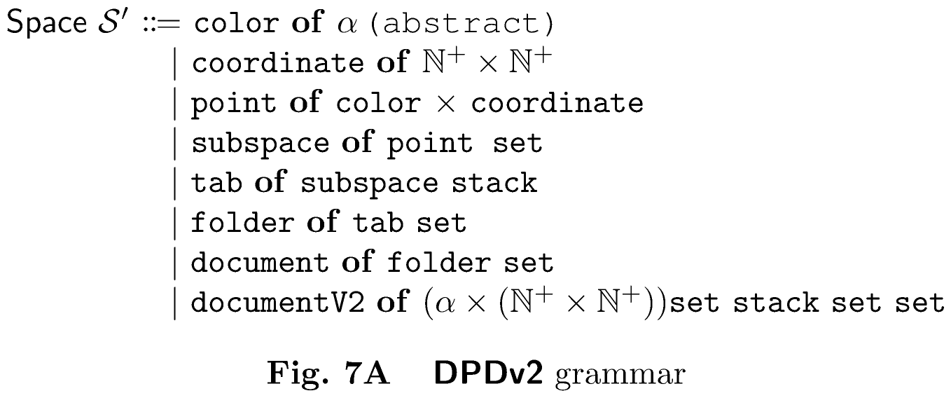

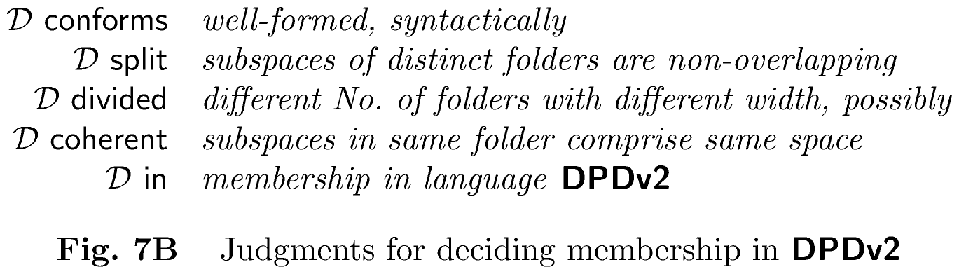

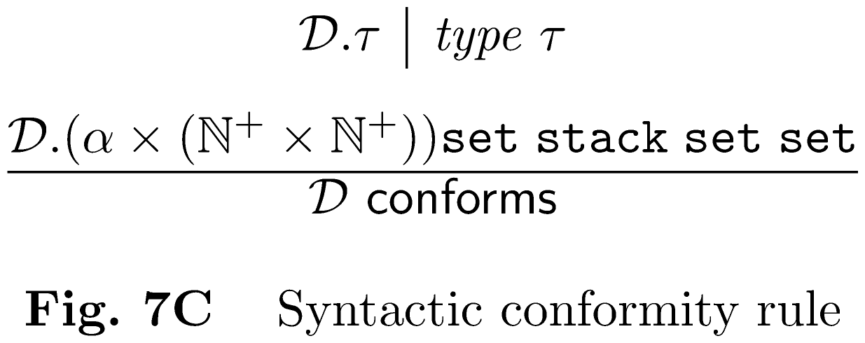

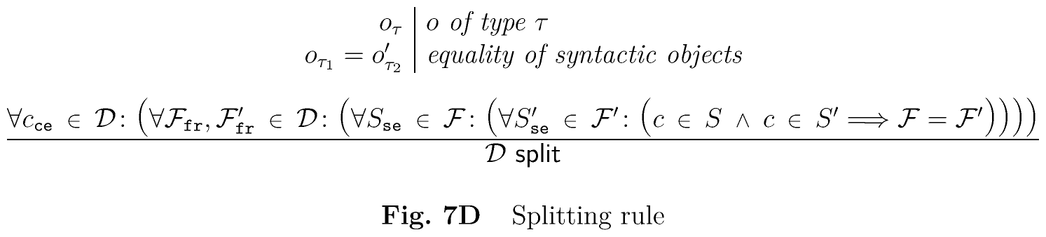

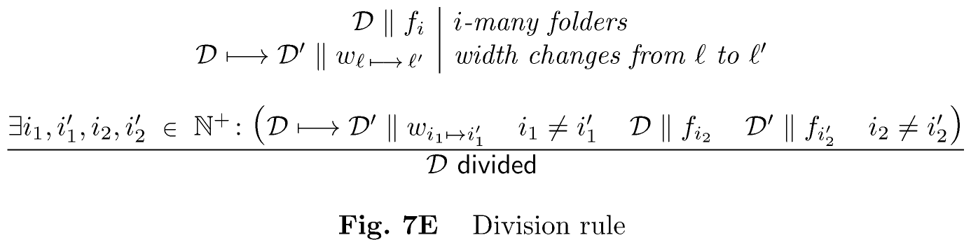

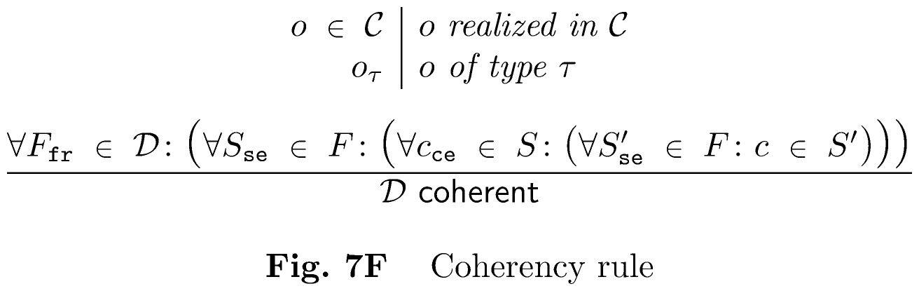

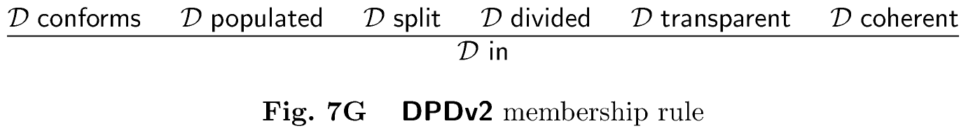

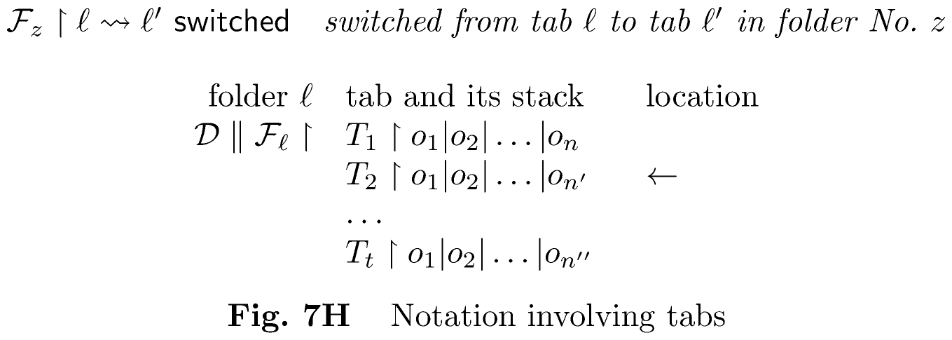

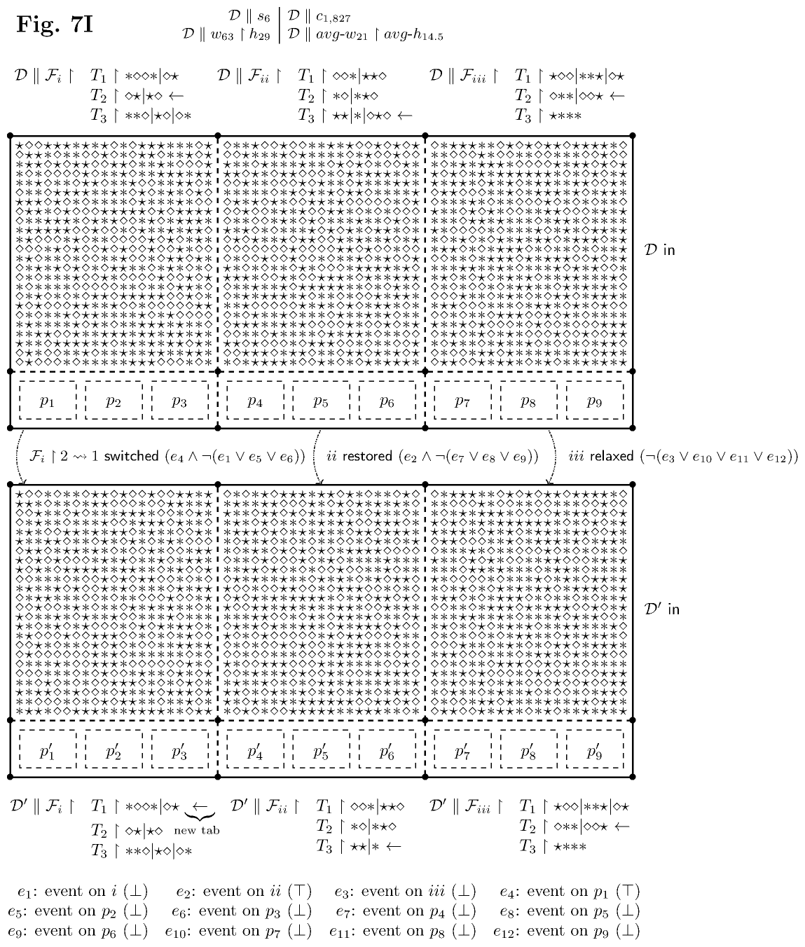

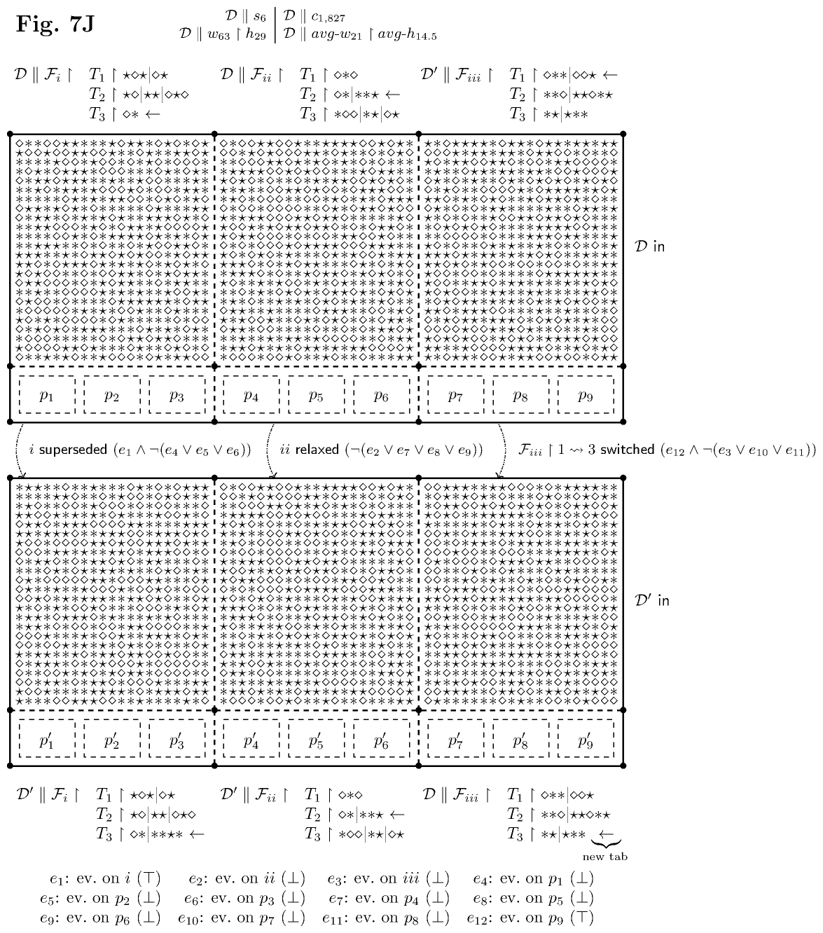

Referring now to FIG. 7A, we give a grammar for a more involved language of dynamically-partitioned documents, which we call DPDv2:
Space [symbol] ′::=color of α (abstract)
         |coordinate of [symbol] ⁺× [symbol] ⁺
         |point of color×coordinate
         |subspace of point set
         |tab of subspace stack
         |folder of tab set
         |document of folder set
         |documentV2 of (α×( [symbol] ⁺× [symbol] ⁺))set stack set set

Its difference from the language DPD is that it allows multiple stacks of subspaces for individual portions of the documents, whereas previously there was allowed only a single stack of subspaces for each portion. This elabora-tion gives the user further opportunities for selectively manipulating portions of the documents and promptly revisiting previous information. The user switches between and manipulates distinct stacks of subspaces within the same portion of the document, preserving the contents of earlier such stacks.

In FIG. 7B, we introduce informal judgments for deciding on membership in DPDv2:

| | |
|---|---|
| [symbol] conforms | well-formed, syntactically |
| [symbol] split | subspaces of distinct folders are non-overlapping |
| [symbol] divided | different No. of folders with different width, possibly |
| [symbol] coherent | subspaces in same folder comprise same space |
| [symbol] in | membership in language DPDv2 |

We say that [symbol] conforms if it adheres appropriately to the foregoing grammar. We assert that it is split if subspaces of distinct folders are non-overlapping. We say it is flexible if there is some different width with a different No. of folders. We write that it is coherent if each of the subspaces under an arbitrary folder comprise the same space. We say it is in if it has membership in our new, more involved language DPDv2.

In FIGS. 7C-G, we introduce rules that allow us to formally decide on membership in DPDv2.
[symbol] . We express with the rule

$$\frac{𝒟 . ( α \times ( {ℕ}^{+} \times {ℕ}^{+} ) ) set stack set set}{𝒟 conforms}$$

that [symbol] conforms if it is of appropriate type, namely, (α×( [symbol] ⁺× [symbol] ⁺))set stack set set.
[symbol] . The rule

$$\frac{∀ {c}_{c e} ∈ 𝒟 : ( ∀ {ℱ}_{fr} , {ℱ}_{fr}^{′} ∈ 𝒟 : ( ∀ {S}_{s e} ∈ ℱ : ( ∀ {S}_{s e}^{′} ∈ {ℱ}^{′} : ( c ∈ S ∧ c ∈ {S}^{′} ⇒ ℱ = {ℱ}^{′} ) ) ) )}{𝒟 split}$$

asserts that [symbol] is split if for all coordinates c and subspaces [symbol] and [symbol] ′ in [symbol] , the occurrence of c in both [symbol] and [symbol] ′ implies the appearance of [symbol] and [symbol] ′ under the same folder. (This rule is a variant of the separation rule from earlier.)
[symbol] . The rule

$$\frac{∃ {i}_{1} , {i}_{1}^{′} , {i}_{2} , {i}_{2}^{′} ∈ {ℕ}^{+} : ( 𝒟 ↦ {𝒟}^{′} ‖ {w}_{{i}_{1} ↦ {i}_{1}^{′}} {i}_{1} \neq {i}_{1}^{′} 𝒟 ‖ {f}_{{i}_{2}} {𝒟}^{′} ‖ {f}_{{i}_{2}^{′}} {i}_{2} \neq {i}_{2}^{′} )}{𝒟 divided}$$

asserts that if [symbol] can change its width from [symbol] ₁ to [symbol] ′₁ (D [symbol] [symbol] ′∥wᵢ_{₁} [symbol] _{i′}_{₁}) and in effect modify its No. of folders from [symbol] ₂ to [symbol] ′₂, then [symbol] is divided. (We write [symbol] ∥ [symbol] to assert that [symbol] has [symbol] -many folders. This rule is a variant of the flexibility rule from earlier.)
[symbol] v. The rule

$$\frac{∀ {F}_{fr} ∈ 𝒟 : ( ∀ {S}_{s e} ∈ F : ( ∀ {c}_{c e} ∈ S : ( ∀ {S}_{s e}^{′} ∈ F : c ∈ {S}^{′} ) ) )}{𝒟 coherent}$$

expresses that [symbol] is coherent if each subspace under an arbitrary folder shares precisely the same coordinates/space. (This rule is a variant of the layering rule from earlier.)
v. The last rule

$$\frac{𝒟 conforms 𝒟 populated 𝒟 split 𝒟 divided 𝒟 transparent 𝒟 coherent}{𝒟 in}$$

allows the conclusion of membership in DPDv2. It exploits the judgments specified immediately above as well as ones specified earlier.

In FIG. 7H, we specify notation to be used in the remaining figures:
[symbol] _{z} [symbol] [symbol] ′ switched switched from tab [symbol] to tab [symbol] ′ in folder No. z
   folder [symbol] tab and its stack location

$$\begin{matrix}𝒟 ‖ {ℱ}_{ℓ} ↾ & {T}_{1} ↾ {o}_{1} \vert {o}_{2} \vert … \vert {o}_{n} \\ & \begin{matrix}{T}_{2} ↾ {o}_{1} \vert {o}_{2} \vert … \vert {o}_{{n}^{′}} & ←\end{matrix} \\ & … \\ & {T}_{t} ↾ {o}_{1} \vert {o}_{2} \vert … \vert {o}_{{n}^{′′}}\end{matrix}$$

It specifies each of the tabs and their subspaces under folder No. [symbol] . The tab the user is under is indicated with the arrow ←. We furthermore introduce a judgment, [symbol] [symbol] [symbol] [symbol] [symbol] ′ switched, expressing that the user switched from tab [symbol] to tab [symbol] ′ in folder No. z.

In FIG. 7I, we illustrate the transformation of a document with membership in our language DPDv2. Such membership is indicated towards the right of documents [symbol] and [symbol] ′ with the judgments that they are in. The document [symbol] has three folders, each with three tabs. The No. of subspaces under each tab is in the range of 1-3. The subspaces visible from the perspective of the user are the ones at the top of the tabs that the user is under. The “top” is towards the right, and the tab the user is under is indicated with the arrow ←. In [symbol] , the subspaces with identifiers *★⋄, ⋄★⋄, and ⋄⋄★ are visible; in [symbol] ′, the subspaces with identifiers ⋄★, *, and ⋄⋄★ are visible. We write the judgment and propositional formula [symbol] ᵢ [symbol] 2 [symbol] 1 switched (e₄∧¬e₁∨e₅∨e₆)) to indicate that user input occurred on the indicium marked p₁, in effect switching the tab from the second to the first one in folder No. [symbol] . A new sequence of symbols over Σ hence appears in the leftmost “main” subspace of [symbol] . The judgment and propositional formula [symbol] restored (e₂∧¬(e₇∨e₈∨e₉) are written to indicate that user input occurred in the second “main” subspace to “close” a subspace, thereby removing the subspace at the top of the third tab of folder [symbol] . A new sequence of symbols over Σ appears in the second “main” subspace of [symbol] ′, evincing the new information contents of the subspace consequently atop the third tab of folder [symbol] . An absence of user input and transformation in and below the third “main” subspace is indicated with the judgment and propositional formula [symbol] relaxed (¬(e₃ ∨e₁₀∨e₁₁ V e12)).

In FIG. 7J, we illustrate another transformation of a document with membership in language DPDv2. In [symbol] , the subspaces with identifiers ⋄*, **★, and ⋄⋄★ are visible; in [symbol] ′, those with identifiers **★* , **★, and ★** are visible. We write [symbol] superseded (e₁∧¬(e₄∨e₅∨e₆)) to express that user input occurred in the subspace at the top of folder [symbol] to “open” a subspace, in effect pushing a subspace to its third tab. We write [symbol] relaxed (¬(e₂∨e₇∨e₈∨e₉)) to indicate an absence of user input and transformation in and below the second “main” subspace. We write [symbol] ᵢᵢᵢ [symbol] 1 [symbol] 3 switched (e₁₂∧¬(e₃∨e₁₀∨e₁₁) to express that user input occurred on the indicium marked p₉, switching the tab from the first to the third one. Consistent with the foregoing events, a new sequence of symbols over Σ appears in the first and third “main” subspaces of [symbol] ′, and a different sequence appears in the second one.

In an example embodiment, the documents discussed herein may be realized on the World Wide Web with HyperText Markup Language. In a particular embodiment, the documents may vertically partition subspaces, in addition to horizontally partitioning documents as described. Such an embodiment is consistent with invariants of our languages, such as that the visible subspaces are non-overlapping and that they together comprise the entireties of the documents.

### Implementation Options

It should be understood that the example embodiments described above may be implemented in many different ways. The embodiments may be implemented by data processors located within personal or laptop computers, servers, smartphones, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described above, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer-software instructions and data used to implement, for example, the various procedures described herein.

Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program prod- uct can be installed by any suitable software installation procedure, as is well known in the art. In another embodiment, at least a portion of the software instructions may also be downloaded as application software over a cable, communication network, and/or wireless connection from a server to a smartphone, laptop, personal computer, tablet, or other device.

Embodiments may also be implemented as instructions stored on a non-transient machine-readable medium, which may be read and executed by one or more procedures. A non-transient machine-readable medium may include any mechanism for storing or transmitting information in a form read-able by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. An apparatus, comprising:
one or more processors;
a non-transient machine-readable memory with instructions executed by the one or more processors to dynamically partition and supersede a plurality of subspaces nested in a document, the operations comprising:
maintaining a plurality of subspaces nested in a document, the subspaces housing information;
in response to an increase in the size of the document:
either appending a subspace to the document and decreasing the size of one or more of the existing subspaces; or
increasing the size of one or a plurality of the subspaces nested in the document; and
in response to a decrease in the size of the document:
either removing a subspace from the document and increasing the size of one or more of the remaining subspaces; or
decreasing the size of one or a plurality of of the subspaces nested in the document; and
at one of a plurality of the subspaces nested in the document:
in response to user input on an indicium in the subspace:
superseding the subspace with a subspace having different information.
